(19) United States
(12) Patent Application Publication
(10) Pub. No.: US 2009/0024417 A1
(43) Pub. Date: Jan. 22, 2009

(54) ELECTRONIC MEDICAL RECORD SYSTEM

(76) Inventors: Richard D. Marks, McLean, VA (US); William A. Knaus, Charlottesville, VA (US)

Correspondence Address: JAMES REMENICK;NOVAK DRUCE & QUIGG, LLP, 1300 I STREET NW, SUITE 1000 WEST TOWER, WASHINGTON, DC, 20005, US

(21) Appl. No.: 12/172,742

(22) Filed: Jul. 14, 2008

Related U.S. Application Data
(63) Continuation-in-part of application No. 09/816,152, filed on Mar. 26, 2001.
Application No. 09/816,152 is a continuation-in-part of application No. 09/822,261, filed on Apr. 2, 2001.
(60) Provisional application No. 60/949,750, filed on Jul. 13, 2007.

(51) Int. Cl. G06Q 50/00

(52) U.S. Cl. 705/3; 705/2

(57) ABSTRACT

This invention relates to electronic medical records and in particular records that are owned, managed, and controlled by a patient or a person with appropriate authorization to act for the patient, and, in particular, to the establishment and management of a PHR (electronic personal health record) for efficient and effective presentation to a user. The invention also relates to creating structured medical information within the PHR and the differential presentation of that information such that immediate determinations of reliability can be made on the quality and accuracy of the medical information. Further, the invention relates to a PHR that is apportioned into active and inactive area such that only active portions are viewed by health-care providers who are granted routine access. This maximizes the information presented to the provider and minimizes the provider's need to review non-relevant and/or especially sensitive information. The invention also provides for archived files for the maintenance of PHR information.

### REFERENCE TO RELATED APPLICATIONS

This application claims priority to U.S. Provisional application No. 60/949,750 entitled “Patient Command: System for a Primary Personal Health Record to Manage Health and Health Care,” filed Jul. 13, 2007.

### BACKGROUND

1. Field of the Invention

This invention relates to electronic medical records and, in particular, to the establishment and management of those medical records. The invention also relates to methods in which the medical records are accessed and presented, and to the management of medical information.

2. Description of the Background

There is widespread recognition in government and the health care community that health care is woefully lacking in its ability to use information technology to improve care and reduce costs. Government supports programs, and expects to develop new legislation, to speed the creation of personal electronic health records. Public and private sector studies support using personal health records, or PHRs, that is, medical records managed or controlled by patients, to help reduce medical errors, eliminate unnecessary medical tests, improve consumers' decisions about where and how to seek medical care, and reduce costs overall in the health system.

Much political, governmental, and private sector effort has been aimed at business and technological models to network hospitals and doctors' offices so that a person's health records can be assembled at any given point of care whenever an electronic query is broadcast. The basis of that proposed system is “record locator” or “pointer” technology. That technological approach is unworkable and will fail, despite plans for massive efforts to attempt standardizing health care information technology.

In contrast, the workable solution is a secure, central repository for individuals' and their families' primary, vetted health records, which are under the control of the individual such as is described in United States Patent Publication Nos. 2002/0016923 and 2002/0004727, both entitled “Broadband computer-based networked systems for control and management of medical records” and both of which are hereby entirely incorporated by reference). Such a system, which serves as the individual's trusted agent, acts as a bank for the individual's secure, primary, vetted, cumulative personal health record or PHR—which consumers will control and distribute as they see fit. The information in the records of this system is drawn from many sources by a variety of means, which is warranted by the input vetting process, and directed to accuracy of transcription. That way the patient's own primary cumulative personal record can be used in treatment—providers will be able to rely on it. (Hospitals and physicians' offices will still have their own institutional records for the patient, and new entries in those records will be obtained to update the patient's own PHR, which will be the patient's primary record.) The system is friendly to hospitals and physicians' offices and operates with the legacy systems offered by a wide variety of health care information technology vendors.

Large employers and state governments with Medicaid programs can use such a system to lower health care costs while improving the health care decisions of their employees and constituents. This empowers individuals to bring informed self-interest to bear on management of their health and medical care choices.

Even before the widespread implementation of electronic medical records, or EMRs, in doctors' offices, hospitals, clinics, and similar facilities, there are great benefits in efficiency, cost reduction, patient safety, and improved outcomes from implementing PHRs, because PHRs allow patients to better manage their health and to better, and more efficiently, interact with providers of care in the health care system, both domestically and, if the situation arises, in other countries.

Nevertheless, with the implementation of electronic medical records, the records are being input into medical records databanks exactly as they appear in the personal health records. This is inefficient and makes the EMR difficult to work with. Improvement is needed that would structure electronic information in a manner such that presentation of the data and therefore treatment options as efficient and useful as possible.

### SUMMARY OF THE INVENTION

The present invention is directed to systems and methods for the establishment and presentation of PHR information.

One embodiment of the invention is directed to electronic health records comprising health care information obtained from multiple sources, wherein the information contained within one or more records contains an indication of reliability. Preferably the indication of reliability is an identification of source information or an identification of mode of input by which the information is entered into the electronic health record. Preferred sources include, but are not limited to a hospital, a physician, a nurse, a pharmacy, the patient, or a combination thereof. Preferred modes of input by which the information is entered into the PHR, or patient-based personal electronic health record, include imaging a paper record, facsimile, electronic transfer, or a combination thereof. The indication of reliability may be optionally displayed as determined by the user of the information, which may be the patient to which the record pertains or a guardian of that patient, or a professional provider of health services such as a physicians. Preferably, both the mode of input and the source identification are displayed together and simultaneously on a screen at the option of the user.

Another embodiment of the invention is directed to a health record database comprising a plurality of the electronic health records of the invention, wherein each record is capable of being individually displayed and individually supplemented with additional health information, wherein the indication of reliability contains both a source identification and a mode of input by which the information is entered into the record.

Another embodiment of the invention is directed to a method for creating or supplementing an electronic health record, and in particular a PHR, comprising: inputting heath information of a patient into an electronic database; and inputting an indication of the reliability of said information. Preferably the indication of reliability comprises a mode of input by which the information was acquired and/or an identification of the source of the information. Preferably the indication of reliability is optionally displayed or hidden as desired by the click of an icon on a computer screen.

Another embodiment of the invention is directed to a health record bank (HRB) or other similar system for PHRs comprising a plurality of electronic health record wherein one or more of said records of the bank are subjected to a data quality review. Preferably, the data quality review comprises a vetting process wherein errors, duplications, omissions, inconsistencies or combinations thereof in medical information in the electronic medical record are identified. Also preferably, the vetting process further comprises annotating the record to identify that there are suspected errors, duplications, omissions, inconsistencies or combinations thereof in the medical information of the electronic medical record. The method my also preferably comprise annotating the record to identify all suspected errors, duplications, omissions, and inconsistencies of the electronic medical record.

Another embodiment of the invention is directed to an electronic health record, and in particular a PHR, database comprising multiple electronic health records created or supplemented by the method of the invention.

Another embodiment of the invention is directed to an electronic health record, and in particular a PHR, database comprising multiple electronic health records of multiple patients wherein one or more health care records contain a primary personal health record component and an inactive archival component. Preferably, the inactive archival component is not accessible to a viewer of the primary personal health record component without authorization of the patient.

Other embodiments and advantages of the invention are set forth in part in the description which follows, and, in part, will be obvious from this description, or may be learned from the practice of the invention.

### DESCRIPTION OF THE INVENTION

Glossary

CMT (Care Management Team). The CMT is comprised of a group of individuals which typically, and, at the patient's election, includes treating and consulting physicians, nurses, the patient, and/or the patient's friends, relatives, and/or other advisors.

Care Management Team Conference. The interactions between the individuals of the CMT, which may be conducted entirely within the HRB or other PHR system or organization.

DQR (Data Quality Review). An input or vetting system that identifies and annunciates errors, duplications, omissions and/or inconsistencies in medical information, which can then be checked and if necessary corrected, before the information is input into the PHR.

EHR (Electronic Health Record). An institutional medical record created by a provider, such as a doctor or hospital, to document its clinical processes with respect to a patient.

Health History. A PHR that has a chronological history of all or a portion of a patient's medical and health-care information.

HIPAA right of access to medical records. The right of patients under HIPAA (the Health Insurance Portability and Accountability Act of 1996), on request to a doctor, hospital, or other provider, to receive copies of their medical records; if the records are in electronic form, patients are entitled to request and receive the copies in electronic form.

Inactive Archive. The specially compartmented portion of a PHR, that is, a part of the PHR that can be seen by a viewer of the PHR only if the patient (or person, such as an account holder, who is managing the PHR on behalf of the patient) grants that viewer particular rights to the Inactive Archive. The Inactive Archive thus is not routinely available to viewers of the PHR who are granted access to it, such as doctors, nurses, social workers, or others.

Interoperability. The ability of electronic devices, measured on a spectrum of capability, to operate and communicate usefully with one another, typically through standard protocols and data structures.

Legacy systems. The computer systems installed in doctors' offices and hospitals; these systems come from a variety of vendors, use different operating systems, data structures, and communications protocols, and typically are not interoperable.

PHR (Personal Health Record). A collection of electronic medical records about a patient that is assembled from a variety of doctors, hospitals, and other providers; it is owned and controlled by the patient. PHRs may contain text and images such as, but not limited to, X-rays, CAT scans, MRIs, and PET scans. Preferably the record is owned, managed, and/or controlled by a patient or a person with authorization to act for the patient who is not a health care worker directly involved in creation or supplementation of health care information of the PHR.

Primary Personal Health Record (Primary PHR). A compilation, typically in an electronic database or similar system, of a person's medical records from a variety of providers that is owned, controlled, and managed by the patient (or person, such as a parent or guardian, acting for the patient), so that access to the compiled record, including for input, output, and data management, is controlled by the patient; subject to rules and procedures of the provider of the electronic database or system.

Semantic Interoperability. The ability of two or more computer systems to exchange information and have the meaning of that information accurately and automatically interpreted by the receiving system.

In many ways the healthcare system is excellent. Medical schools offer superb training and produce outstanding doctors. Doctors practice in world-class facilities and have access to the best tools. And yet everyone involved acknowledges that the system is broken. The problem, quite simply, lies in the process of delivering the benefits of this excellence to the patients in need—a process fundamentally compromised by patient health records created for legacy systems using legacy methods, with little or no thought given to interoperability.

A clinical Tower of Babel now exists in which a single syndrome may be described differently, depending on the medical discipline and its record-keeping conventions. Drugs, symptoms, indications may all have different descriptions depending on the branch of medicine, or the delivery system. More than 70% of doctors use paper records, which are breeding grounds for error, and society loves to litigate when mistakes occur. Additional research shows that fully 20 percent of all medical records contain incorrect information.

In such an environment it is not surprising that the notion of a personal health record (PHR) that can be universally trusted among all clinicians seems far-fetched. Untangling all of the inconsistencies and bad information will dramatically improve the process of health care delivery in a timely manner and at lower cost. Many have tried but none has gained more than partial success or shows any signs of doing so in the near future. The creation and management of personal health records will go a long way to alleviating and improving health care for everyone.

It has been surprisingly discovered that the manner, maintenance, and collection as well as the presentation of health information can substantially improve health and specifically medical care. Collection and presentation of health information according to the invention not only improves direct care including prevention, but improves the accuracy and reliability of the personal health record medical information. Information that can be input into a PHR includes, but is not limited to information such as, for example, data, diagnostic information, test procedures that are to be performed or already performed, test results, physician or health-care worker opinion or observation, medication information, and combinations thereof. Further, the invention provides for a substantial improvement in the reliability of information through source identification and input identification. Source identification includes, but is not limited to identification of input, for example, as doctor-provided, nurse-provided, patient-provided, user-provided, health-care official-provided, pharmacy-provided, insurance company-provided, parent-, trustee- or guardian-provided, attorney- or court-provided, hospice-provided, fiend- or acquaintance-provided, health-care worker-provided, or any combination thereof. Input identification includes, but is not limited to, information that is received for input into a PHR by facsimile transmission, by electronic transmission over the Internet or a direct or indirect computer connection (such as by electronic mail), by direct imaging, by transcription, or by any combination thereof. Information on source identification and input mode may be optionally revealed by the user or member as desired. As shown below, source identification and input mode identification may be hidden or revealed within the viewed medical record as desired with the click of a mouse on a screen icon:

HIDDEN: . . . includes a diagnostic test for cancer . . . .

REVEALED: . . . includes a diagnostic test for cancer (provided by Dr. Smith from United Hospital; submitted by facsimile) . . . .

Source and mode of submission identification can be presented in any manner or form or structure. It is only needed to provide the viewer (e.g. the doctor, health-care worker or patient) a legend explaining the system, whether or not immediately obvious to the viewer. For example, information could be color coded for reliability, placed into the record in different fonts or character sizes, or even simply italicized (as shown above). Additional identifier of reliability can be added to show to the viewer any information that speaks to the reliability of the data, or each item of the data, in the record. Preferably, the HRB or other PHR provider organization may add additional information when data appears outside of the normal or expected values for a normal patient, for a patient with the conditions of the particular patient (e.g. age, weight, sex, disorder stage), or even that individual patient (hemoglobin level, glucose level, RBC (red blood cell), WBC (white blood cell) and platelet count). Although an important aspect is simply determining the reliability of the information in the record, the quantity and quality of that information is equally important to the viewer and therefore presentation is critical.

The systems and methods of the invention focus on data quality, legal worries, and cultural barriers in health care. Thus, it is not necessary to wait decades for the nirvana of interoperability and full and complete compliance by doctors and hospitals with the clinical electronic data processing standards at some time in the future when interoperability of clinical data systems is the norm throughout most of the Unites States and/or the rest of the world.

Further, the invention leverages patients' rights under HIPAA, so doctor and hospital permissions are not required. Yet the invention saves clinicians hassle and cost, which is apparent even to those with no business reasons for adopting electronic records, because the invention enhances safety and quality care.

PHRs marketed today make people see conflicts of interest and therefore danger. Uptake of PHR's is low as is acceptance. PHRs will enjoy widespread adoption and use only if people trust the PHR system. Trust in turn demands offering consumers real, concrete control over their PHRs, and trusting consumers to be sufficiently smart to use PHRs in their own self-interest. In short, the invention puts consumers in control, yet, through quality control features, offers clinical credibility to physicians and other caregivers so that the PHR and the data in it are clinically useful.

In one embodiment, the invention is directed to a process referred to as data quality review. This is an input process that searches medical records from diverse sources for mistakes, ambiguities, and contradictions in order to help resolve discrepancies. The result: An individual's Primary Record that is more accurate than the many source records from which it is compiled. The invention creates a Primary Personal Health Record that is believed and trusted by clinicians as well as patients.

The invention is also directed to a secure central depository—a bank for data—and thus a win for users whose privacy is guaranteed because they will have control of all their medical records. The invention is also a win for clinicians by providing them with a health record they can believe and trust, and thus enable them to speed the delivery of care. The invention is a win for the many large entities who underwrite health care plans for their employees by promising better results for employees while delivering millions in savings. The invention changes the paradigm of health care delivery, and this aspect alone gets to the heart of medicine's most pressing problem—process—decades before clinical data systems become interoperable.

### Data Quality and the Primary Health Record

Trust is at the heart of the quest for interoperable PHRs. The invention's health records can be trusted because of their enhanced data quality, derived from process innovations that only the invention is taking to the marketplace. Quality-control in compiling personal medical records will transform the competitive landscape.

Because they can be trusted, Primary Personal Health Records of the invention enhance safety and quality of care. Data quality review according to the invention makes PHRs useable by clinicians—and essential for safe care—precisely because the proprietary input process searches medical records from diverse sources for errors, ambiguities, and contradictions. The result: An individual's Primary Record will be more accurate than the source records from which it is compiled. The proprietary output process also allows clinicians easily and efficiently to identify the source and input method of each items of data in the PHR. Thus they can make clinical judgments, data element by data element, as to the clinical weight to accord each data item in the compiled record.

Trust makes primary personal records of the invention credible to clinicians and patients alike. Data quality review enables individuals to use their primary record for managing their relationships with doctors, hospitals, and other caregivers. No other PHR offers this trusted foundation. Users are able to manage their health and health care better, because they have their primary source of trusted medical records at their fingertips. The invention provides a secure, central repository—a bank—for individuals' primary health records.

### Types of Medical Information

Personally identifiable information is information or other data that may specifically identify an individual user. It includes contact data such as name, mailing address, and electronic mail address. Any information in a communications may be collected as personally identifiable information. Traffic data is information about a user's patterns of access and use of our site. Traffic data is automatically collected and analyzed from the site, including Internet Protocol address, domain server, type of computer, and type of web browser. Traffic data may be anonymous or it may contain personally identifiable information.

In many circumstances, an IP address, an email address, or other information may be linked in certain databases, such as those maintained in Internet registries, credit-reporting data bases, and government databases, to personally identifiable information. A “cookie” is a short section of computer code that is sent to a person's computer for storage on its hard drive. Cookies allow web sites efficiently to perform certain communications and data functions with users of the sites.

Collection and Use of Personally Identifiable Information and Sharing Personally Identifiable Information with Third Parties

In one embodiment of the invention, the user transmits some personally identifiable information, including user name and email address. The invention uses personally identifiable information that it collects to assess and formulate business strategy, including decisions about potential strategic partners and investors (and for related purposes). In this process, the invention may share personally identifiable information collected with attorney, advisors, and contractors (including, among others, service providers), all of whom are or may be under obligations of confidentiality.

### Security

Presented below are three sequences to illustrate how individuals utilize the invention through a central organization with each user being a member of the group. The first sequence, for the person joining as a Member, presents the greatest design challenges of holding interest, not being discouraging, and being easy to use. The third sequence is an example of what is illustrated.

### Individual as the User

If the person stops any time after they get their ID, log off, and get re-directed to the sequence when they log back in where they provide instructions on security, privacy, and emergency access for creating their PHRs (or, as used here synonymously with PHRs, their Health Histories).

If people have questions at any point, they can use the tabs to navigate to pages where they can get explanations for the choices that need to be made in this initial mandatory Member registration sequence. They can also go off and explore the site, but eventually they must return to their place in the initial mandatory sequence and finish it before starting input to their Health Histories. If the person is getting help from a social worker (e.g., the Member is a Medicaid recipient or union member), the social worker will start the sequence with the Medical Record Social Worker Computer Interface as follows:
Member logging in to use Health History
Member home
Member's Health History 1/(Basic)/0.2/(Enhanced)/ or 0.3/(Comprehensive)
Then Member makes security and privacy choices depending on what the Member prefers
Member logging in to set up a collaboration with the Member's doctors, family members, and other advisors so that they have access both to the Health History and to the Team Conference feature of the PHR
HH side-by-side comparison to illustrate how the Member might want to set things up for use by the Member, by clinicians, or for a group discussion.

A Primary Health Record keeps a health history and important personal medical records in one place wherein all or some of a patient's medical records from many sources come under the patient's control. The PHR is the primary place to store records and the primary place to go when records are required to manage health and health care. The PHR of the invention allows doctors to help the patient and is an important key to safe, high quality care. Want to know about new treatments for a specific disease? Want to know about clinical trials for particular health problems? Interested in ways to participate in research for a disease or health problem that affects you? Care about opportunities to give or sell your health information for research or marketing? The patient (the Member of the PHR system) can instruct the PHR health data bank or other PHR system provider to inform the member when these opportunities come up; but the choice is the Member's. Members store and safeguard their own medical information in health histories.
Patients have a legal right to get copies of their medical records from doctors, dentists, hospitals, clinics and other health care providers.
These records are sent to a central repository of the invention.
The invention stores the medical records electronically and securely in a PHR (Health History) that the patient owns and controls.
The invention helps protect the Patient's privacy.
   Why do patients want Health Histories for themselves?
It's easier to deal with doctors and hospitals when a patient has a Health History.
Patients can manage their health better when they have their own Health Histories.
A Health History helps a person, whether or not yet a patient, be a Resourceful Health Care Consumer.
A person, such as a PHR member, can opt in to participate in receiving information about medical research and clinical trials for health issues of interest to the person or the person's family.
   Why do people want a Health History for each family member?
It is easier to help with family health problems when each person has a Health History.
It is easier to help family deal with doctors and hospitals when each person has their own Health History.
The family can help each other be Resourceful Health Care Consumers.
   Do people need copies of their medical records before the can become Members?
No! The easiest way to start is to register as a Member first, and then gather medical records to start the Health History.
The information repository guides its Members in starting their Health Histories. This can be done on their schedule and at their own pace.

One embodiment of the invention is a bank for peoples' Health Histories. It stores Health Histories securely and electronically. Just as a bank works for its depositors, methods of the invention works for patients—for the health care consumer. This is called a health record bank.

With a Health History it is easier to become a Resourceful Healthcare Consumer. People are better equipped to manage your health and health care. They will find it easier to deal productively with doctors and hospitals. And their records can be available over the Internet world-wide in an emergency.

Records are “trusted” because they are put them through a screening, or vetting, process when the go into the Health History. One purpose of vetting is to try to find errors in patients' existing records. Each time an error is found, there's a chance to correct it by annotation.

The Health History may be more accurate than the records being stored at various sources in doctors' offices and hospitals.

The invention works the patient. PHRs of the invention strive to be the patient's trusted agent in storing and safeguarding information obtained from their medical records—even though all the doctors and hospitals they visit probably are storing information about them in their separate record systems to document their own particular work.

As the patient's trusted agent, the invention allows:
Send news about particular health problems or diseases;
Send news about clinical trials that may be interesting to the patient;
Notify the patient of opportunities to have his or her personal medical information used in research studies on an anonymous (“de-identified”) basis;
Notify the patient of opportunities to have their personal medical information used in research studies when the researchers can identify the patient (the personal information is not “de-identified”);
Notify the patient when medical researchers or others might want to pay him or her to use their medical information, whether or not it is de-identified.

However, these things are performed only if the patient opts in. Privacy is important and it is under the patient's control. If the patient decides not to opt in, there is may be no penalty, no extra cost, and no pressure. The invention is not a government agency, nor are the systems, tools and methods part of any public health agency, law enforcement agency, insurance company, or hospital. The invention's mission is to be the trusted agent for consumers who seek to create, store, and use their vetted health histories to better manage their health and health care and that of their families. The invention operates secure, redundant storage facilities and customer assistance centers at one or more locations within the United States and/or elsewhere.

### The Invention is the Consumer's Bank for Personal Health Information

The invention works for the patient, the health care consumer and, therefore, the system is the consumer's trusted agent, very much like a bank—but a bank where the patient deposits, owns, and controls their Health History, just as they own and control their savings and checking accounts at a financial institution. The invention does not work for the government (federal or state), employers, health insurance companies, health plans, pharmacies, doctors, or other health care providers, but only for consumers and their families. Of course, the methods of the invention operate to makes the health care process easier for doctors, hospitals, health plans, and a long list of other health care professionals. The invention's services also reduce the total cost of health care, and make it easier for consumers to manage their health and health care more efficiently. That saves money for everyone, including governments. The invention make it possible for everyone (on both sides of the digital divide) to learn enough about their health to become Resourceful Healthcare Consumers.

### Members' Health History

It's easy to be a Resourceful Health Care Consumer—and consumers are better off as a patient—when they have a Health History.
They don't have to try to remember the same old information every time they visit a different doctor or hospital.
They can work better with doctors because they have more accurate and complete historical information about their health and health care—for example, doctors who use computers can quickly search a patient's Health History.
In an emergency, a patient's Health History can be available via the Internet anywhere in the world.
The Health History is stored securely, and the consumer is in control of who gets to see it—the consumer is in command of their privacy.
   Members have a Choice of Three Different Health History Levels:

| | Initial Cost/ | Types of Clinical | Size |
|---|---|---|---|
| | Annual Renewal Cost | Information Stored | Limit |
| Basic Health | | Text only - no clinical | 1 gigabyte |
| History | | imagery | |
| Enhanced Health | | Text and clinical | 5 gigabytes |
| History | | imagery that does not | |
| | | in total exceed 5 | |
| | | gigabytes | |
| Comprehensive | and up, | Text and all clinical | None, but cost will |
| Health History | depending on | imagery | rise according to |
| | computer storage | | computer storage |
| | requirements | | requirements |

Members can change levels when they need to store more information than a lower level can hold. Doctors, hospitals, and other health care providers are required by federal law to furnish copies of your medical records when consumers ask for them. If the records are in electronic form, then consumers are entitled to an electronic copy. Doctors and hospitals can even send these copies by e-mail directly.

Whenever copies of a consumer's medical information go into their Health History, the information goes through the proprietary Data Quality Review (DQR) process according to the invention. DQR helps spot errors or inconsistencies, which can then be checked and corrected before they are re-input. This opens the possibility that the data in a consumer's The Health History will be more accurate than the information in their original medical records. For details about choosing the Health History category that is right for a particular consumer, that person can go to a page for selecting their Health History.

The Invention Protects Members' Privacy—how Opt in Allows Members to Receive Only Information they want to See

According to the invention, members own and control their own PHR Health Histories. They also control additional information, if any, that is sent their way. Members have an Inactive Archive in their Health Histories. Members can store very old or very sensitive information in the Inactive Archive. This streamlines the information for doctor review when the doctor is given access to the member's Health History for treatment. It also allows for control over who sees especially sensitive information stored as part of the PHR Health History.

A basic rule is that health information is sent only if the Member specifically requests and authorizes it. This is part of the opt-in principle. If Members opt in to receive health information, it is sent to them automatically. On the other hand, if they do not opt in, it is not sent (except the information necessary to administer their Health Histories). This rule is designed to protect Members' privacy. It allows Members to own and control their Health Histories, and not have to deal with any other health news if they don't want to. At the same time, Members who want to see health news can get some or all of it. Many Members want to see health news that relates to specific medical conditions or diseases of interest to them or their families. Members who opt in may select any, some, or all of the following health information services:
Information about health conditions or diseases that may affect them or their family.
Information about medical researchers who may want to use their Health History if, and only if, the information is made anonymous (e.g. de-identified).
Information about medical researchers who may want to use their Health History only if they remain identified (they and their records will not be anonymous).
Offers from medical researchers who may want to pay to them for use of some or all of the information in their Health History.
Invitations to participate in clinical trials of interest to them or their family members.
Advertisements from doctors, dentists, hospitals, clinics, and others who offer medical or other health care services of interest to Members who have a particular health condition or disease.
Notifications about epidemics or pandemics such as influenza outbreaks or bird flu.
Other urgent announcements from government health agencies, such as the Centers for Disease Control.

Getting A Member's Medical Information from a Doctor or Hospital People have a right under federal law to get a copy of all the medical records that a doctor, dentist, hospital, or clinic has about them. (The only exception: they do not have a right to “psych notes,” notes of therapy kept and stored separately from other parts of the medical record, from a psychoanalyst or psychologist.) The federal law that gives people this right is called HIPAA (the “Health Insurance Portability and Accountability Act of 1996.”) To get their medical records, people must fill out a HIPAA Authorization. They can fill this out on a computer, or print the form and fill it out by hand. After they fill out the HIPAA Authorization, they can deliver it in person to a doctor, dentist, hospital, or clinic. A doctor's office or hospital normally has 30 days to deliver a paper copy (e.g. photocopy) of your records to the patient. If the doctor's office or hospital needs extra time, they can take an additional 30 days (for a total of 60 days) to make the copies. However, they must notify the patient in writing of the delay. The doctor's office or hospital is entitled to charge the patient for copying the records. This procedure is regulated under HIPAA. Patients should ask in advance what the copying charge is per-page. They also should ask in advance when they must pay (when they place the copy order or when the copy is ready to be picked up). They also should ask whether they can pay by cash, check, or credit card.

Congress passed HIPPA for several reasons. Those reasons include making it possible for every patient to get a copies of his or her medical records from each doctor, dentist, hospital, clinic, therapist, or other health care provider who has seen the patient. As noted above, there is one general exception to HIPAA's general rule that patients are entitled to copies of their medical records. A patient does not have a right under HIPAA to copies of psychology notes written by a psychotherapist (a psychiatrist or psychologist) and kept separate from the other records for the patient. (HIPAA also does not require a doctor or hospital to give patients copies of their records that are compiled for litigation (court) purposes or that are covered by certain special rules for laboratories.) These special rules relate to the Clinical Laboratory Improvement Amendments of 1988. See United States Code, Volume 42, Section 263a and Code of Federal Regulations, Volume 42, Section 493.3(a)(2).

The U.S. Department of Health and Human Services (DHS) in Washington, D.C. enforces HIPAA. DHS has published rules to implement HIPAA. Those rules are known to doctor's and dentist's office, hospital, clinic, and other provider that bills for services electronically. For example, the rules that require a doctor's office, dentist's office, hospital, and clinic to honor a patient's request for copies of his or her medical records are published in the Code of Federal Regulations, Volume 45, Section 164.524.

How does a person make a HIPAA request for my medical records from a doctor, dentist, hospital, clinic, or other provider of medical services? Requesting a copy of medical records from a doctor, dentist, hospital, or other health care provider is easy. A patient must fill out a Request for A Copy of Medical Records. Sometimes they also need a HIPAA Authorization form to give the doctor or hospital permission under HIPAA to send a copy of the medical records. Can patients ask the doctor, dentist, hospital or clinic to give them a copy of their records on a disc or by email under HIPAA? Yes, they can. If the records are “readily producible” in electronic form and format, the HIPAA rules (Section 164.524(c)(2)(i)) requires that the doctor, dentist, or hospital produce the copy in that form. In other words, if the doctor, dentist, or hospital has the records in electronic form or can readily convert the records to electronic form, they must be produced to the patient in electronic form. The records in electronic form can be produced to the patient by electronic mail (e-mail) or on disc. If the doctor, hospital, or other provider doesn't have the records in electronic form, they can be photocopied and given to the patient on paper. If the doctor or hospital gives the patient copies of the records in electronic form, either on e-mail or disc, or if the doctor or hospital gives the patient copies of the records in paper form, they can in all cases be input into the patient's PHR (the Health History). What if the patient's records include X-rays, CAT scans, MRIs, PET scans, or other images in addition to text? Patients can get copies of those images too. HIPAA requires that the patient be given copies of all their medical records (with very narrow exceptions such as psychotherapy notes). Images will almost always be given to patients electronically, usually on a disc but sometimes in an attachment to an e-mail. Patients can then send the electronic image file to their PHRs

### Sending Patients' Medical Information to the Invention

After patients request medical records from a doctor, dentist, hospital, or other health care provider or health plan, they have choices about how to make sure those records get into their Health Histories.
Each patient will need to have their Identifier.
They will also need to be able to authenticate themselves as a Member.
They must make a written request for a copy of their medical information. The request goes to the doctor, dentist, hospital, or other health care provider or health plan who (or that) has the particular records they want copied.
   Then, there are four major ways to get their medical records into their PHR of the invention:
1. Direct e-mailing from the doctor dentist, hospital, or health plan. If the doctor, dentist, hospital, or health plan is willing to send the records by e-mail, patients should give them a HIPAA Authorization that they have filled out. (This is in addition to the written request for records under HIPAA.)
2. Obtaining an electronic copy and e-mail it yourself. If the doctor, dentist, hospital, or health plan will not send the copies by e-mail, the next best thing is for patients to ask for the records to be sent to them by email or copied on to a disk. Then, patients can use their own e-mail to send all the files in the email or on the disk to the PHR of the invention.
3. Mailing a paper copy. If the doctor, dentist, hospital, or health plan does not have an electronic copy of a patient's record, and gives them a paper copy only, they can send that copy by fax, U.S. mail, or express service (such as for example via DHL, FedEx, or UPS) to the PHR of the invention.
4. Scanning-in or self-keying from a paper copy. If the doctor, dentist, hospital, or health plan gives a patient a paper copy and they can scan it or key it into their computer, they can send the resulting files by e-mail.

Patients should know that each time and entry is made to their PHR Health History, there are two notes that also are included. These notes, or annotations, tell how the entry was made. (For example, was the entry sent directly from a hospital? Was it faxed and electronically scanned-in or imaged? Was it keyed in by the Member and sent by the Member using e-mail?). The purpose of these notes is to inform doctors and other health professionals who may read the record. These notes tell the doctor how much they may want to rely on the accuracy of the entry. This is helpful to doctors. It aids their decision-making process, because it supplies another piece of information about each day entry in your Health History. It helps doctors decide on the clinical weight to give each item of information in the PHR based on the item's source and method of input into the PHR. This makes your Health History more credible and therefore more useful to doctors. It therefore enhances the clinical utility of each item of data in the PHR Health History.

### Privacy and Security of the Invention

Privacy is essential to Members. They want to control who sees their Health Histories. Members know they can protect the privacy of their Health Histories through choices they make on the web site of the invention. These choices cover both privacy rules and security procedures. Members control their privacy and security choices. Members make privacy and security choices when they first set up their Health Histories. Members can change these choices at any time.

There are three basic parts of privacy and security according to the invention:
1. Each Member has a unique Identifier.
2. Each Member can authenticate himself or herself.
3. Each Member may opt in to services of interest (such as being notified of medical research for particular diseases or clinical trials). If a Member does not want to know about these services, then the Member does not opt in to them. This protects each Member's privacy.

### Members' Security Options

The Identifier allows each Member to strike a balance between security and convenience. Generally speaking, higher security may cost more and may be less convenient than a lower level of security. The reason is that balance between security and convenience is an individual decision. The choice is under each Member's individual control. Some Members may decide that they do not want very strong security. They may not want to buy extra hardware and software (such as a home fingerprint reader or eye scanner) that is used for higher security. Security involves using different security factors. The invention's minimum level of security requires at least two factors. Security factors are sometimes described as:

### Security Factors Include:

User names. The Identifier is one kind of user name.
Passwords. Some passwords are easy to use and remember. Others are long and may be complicated. Some security experts recommend changing passwords frequently. Others think frequent changes make it too hard for people to remember their passwords. Then people write notes to themselves with their passwords. Those notes can be found by someone else who can then break the account's security. The invention does not require Members to change passwords, because we know people have plenty of trouble managing the passwords they have anyway. Also, Members who think their passwords may have been leaked or otherwise compromised may change to a new password whenever they want.
User-Created Q&A. This method is being adopted by many banks. Many people like it. It works this way: The invention users think up three personal questions and answers about their lives. Only they know the answers. For example, here are three questions and answers that a Member thought up for himself: (1) Who was your first pet? (Answer: Fred the parakeet); (2) Who was the girl you had a secret crush on in 10^{th} grade? (Answer: Betsy); (3) Who was your boss in the summer job you had after high school? (Answer: Ann). Then the Member sends these three questions and answers.

It's highly unlikely that anyone other than this particular Member knows the answers to these questions. It's also unlikely that the Member will forget the answers. After all, they are part of his life. So this Q&A gives the Member a high degree of confidence that access to his PHR Health History will be secure, easy to remember, and convenient. Better yet, he does not have to worry about carrying around a token or smartcard. With the Q&A technique, there is nothing extra to buy, and nothing to misplace and have to pay to replace.)
Security Tokens. The advantage of these devices is that they generate passwords (often in the form of numbers) that can be used only for a very short time. The disadvantages are that they take some training to use, they cost money, and if they are lost they can disrupt a person's computer access and cost the user money to replace.

Smartcards. These devices (which look like a credit card) contain a person's identifying information (such as passwords) that are more complex than typical passwords, and can also contain additional identifying information and health information. Disadvantages include the cost of the smartcard and smart card reader. Smartcards can also be lost and cost the user money to replace.

USB Storage Devices. Universal Storage Bus (USB) devices plug into the back of many newer computers. They are bigger than smart cards, but still small enough to carry in pocket or purse. Generally, they have the same plusses and minuses as smartcards.

Fingerprint readers. These devices are becoming more common on personal computers. They are easy to used, but they are not totally secure—they can be fooled (spoofed) electronically. They cost money. However, generally speaking, they are convenient to use.

Retinal scanners, voice print readers, and similar leading-edge security devices. These devices can offer high security and convenience. Their disadvantages including relatively high cost.

The invention is constantly evaluating new security devices, and offers Members the opportunity to select factors from a list of prescreened and approved choices. Members who select security devices with a higher cost, such as a token, smartcard, or fingerprint reader, must pay the additional cost of the hardware and software. The lowest level of security involves two factors—the combination of the Identifier, which is a kind of user name and a password.

Members have a right to opt in only to those benefits of the invention's services that fits their needs. If a Member decides not to opt in to come or all of these features, that is entirely the Member's decision. This puts Members in control of their privacy at the invention's web site. Some of the services Members can receive on this opt-in-only basis are:
Information about health conditions or diseases that may affect Members or their families.
Information about medical researchers who may want to use Members' Health Histories if, and only if, the information is made anonymous (de-identified).
Information about medical researchers who may want to use Members' Health History only if the Members remain identified (the data will not be anonymous).
Offers from medical researchers who may want to pay to Members for use of some or all of the information in their Health Histories.
Invitations to participate in clinical trials of interest to Members or their family members.
Advertisements from doctors, dentists, hospitals, clinics, and others who offer medical or other health care services of interest to Members with a particular health condition or disease (the invention may make a charge to advertisers).
Notifications about epidemics or pandemics such as influenza outbreaks or bird flu.
Other urgent announcements from government health agencies, such as the Centers for Disease Control.

Some of these opt-in services allow Members to make money by selling selected information in their Health Histories. Whether Members decide this is a good thing is entirely their choice. That is the point of the opt-in system. Some Members will see this as an opportunity. Others may see it as an invasion of privacy. The invention accommodates both points of view. The ability to make the choice is a fundamental right of Members.

The same is true for Members who want to be told about developments relating to health conditions or diseases, medical research, or clinical trials of interest to them or their families. Members own their PHR Health Histories. Therefore, Members who have wills and advance directives should include in those documents how their executors and advance directive decisions-makers should gain access to their Health Histories. This usually requires help from a lawyer.

The Value of Health Histories is in their Credibility

Members use their PHR Health Histories as the primary personal health records for themselves and their families. Members use their Health Histories as important tools to deal more easily and effectively with doctors and hospitals (and other health professionals). This is true for Members' routine health management and for situations where a Member faces a specific health condition or disease.

Health Histories are credible records because their input is checked by a vetting process for accuracy of transcription. Doctors and other health professionals can easily understand how a Health History is compiled, why it is more accurate than many other records, how it can be used to maximum effectiveness, and the extent to which they can rely on it.

Doctors and hospitals will of course create their own records. They may use PHR Health Histories for initial intake (when starting a record for a new patient) and to update records for someone who already is a patient. If an input comes directly from a doctor, hospital, or other health care provider, and whether that input is in electronic form (an e-mail or a disk, for example) or paper form, the Member may not change anything in that input directly from a provider. This procedure is essential to maintain the credibility of Health Histories in the eyes of the medical community. Members may add comments about an entry from a doctor, hospital, or other health care provider to identify errors, explain items, of for other reasons that are important to the Member.

Each entry into a Health History has a note, or annotation, about (1) the input source (for example, a doctor's e-mail or a Member's e-mail) and (2) the input method (for example, an electronic copy from a hospital computer system or a Member's typing or keying in of information obtained from a doctor's office). This procedure is also essential to maintain the credibility and clinical utility of Health Histories in the eyes of the medical community, because it offers clinicians are methodology for assigning clinical weight to each item of data in the PHR Health History.

Only Members can Authorize Access to their Health Histories

Members have the right to give a doctor or hospital access to only part of their Health Histories. Doctors, dentists, nurses, and other health care professionals know that all Health Histories have Inactive Archives. Members may place old or especially sensitive information in their Inactive Archive. A doctor or other health care professional can request access to a Member's Inactive Archive and it may be clearly in a Member's self-interest to tell a particular doctor about information that will help the doctor treat the Member better. This balance is necessary to preserve the credibility of Health Histories in the eyes of the medical community, and at the same time preserve each Member's control over privacy.

The Inactive Archive is Separate from the Current Records Area.

Each PHR Health History according to the invention has a Primary Personal Health Record area and a separate area called the Inactive Archive. Whenever information is put into the Health History, it first goes automatically to the Primary Personal Health Record area. However, the user or Member may move any information entry into an Inactive Archive. Although an electronic entry from a doctor, hospital, or other provider cannot be changed, the Member can decide to move all or part of the electronic entry into the Inactive Archive. Members generally put two categories of medical information into the Inactive Archives of Health Histories.
First, old information that a doctor does not need to review because it is not important to any current condition, diagnosis, or possible treatment.
Second, especially sensitive information that Members may want to store in their

Health Histories, but do not want most people, including most doctors, to see. Each Member has these choices. They give the Member more control over their privacy. Keeping out-of-date information in the Inactive Archive helps the Members' doctors in most cases, because they do not have to review lots of information that is so old that it has no importance for a Member's current treatment or diagnosis. In other words, moving out-of-date information to the Inactive Archive streamlines a Member's records. That lets doctors and other care givers be more efficient in helping the Member.

For occasions when Members need to show a doctor some or all of the information in the Inactive Archive of their Health History, that is easy to do. It requires the Member to grant special, specific access to that doctor or other person. For example, people with illnesses that cannot be diagnosed may want to show their doctors every bit of information in their Health Histories, including the information in their Inactive Archives.

Doctors or nurses who take patients' health histories patients in the traditional setting of an office or hospital do not know, and have no reliable way to know, that information from the patient is accurate or complete. In other words, patients who want to keep secrets can do so easily, and the doctor or nurse has no way of finding out.

### Government Orders to Force Access to Health Histories

The PHR system operator may receive a valid order from a court or a government regulatory agency that forces it to give the government access to a Health History. In the event of such an order, the Member is notified unless the order forbids the PHR system operator from making the notification. (Under some government orders, such as orders issued under the U.S. Patriot Act, it may be forbidden to notify anyone that the order has been received and that access to records has been granted as required under the order.)

Members' Rights and Responsibilities in Getting Copies of their Medical Records and Transmitting the Copies

Whenever Members visit a doctor or hospital (or other health care provider), they should get a copy of the new medical information that the doctor or hospital produces and puts in patients' records. The Member should then use that copy to update his or her Health History. That is how Members' Health Histories are kept current.

To maintain the credibility of PHR Health Histories and to make them easy for doctors and hospitals to use, the PHR system notes the following important items for each entry (and these items can be easily displayed for each item in every Member's Health History):
1. Date of entry
2. Time of entry
3. Source of entry (for example, a doctor, a hospital, a social worker helping a Member, or the Member's own email)
4. Method of entry (for example, an electronic entry direct from a doctor or hospital, or an email from a member).
5. Whether proprietary vetting (entry-checking) process detected a potential problem with the data being entered. (If a problem is detected, the entry is flagged, and the entry may be sent back to the source to be checked and either changed and re-entered or confirmed as correct in its original version.)
   The items are part of the audit trail for each Health History. The audit trail is an important part of every Health History. This process is designed to give Members great flexibility in compiling, reviewing, and using their Health Histories to help manage their health and health care, and in particular to help deal with doctors and hospitals. At the same time, this reinforces the credibility, and therefore the clinical usefulness, of every Member's Health Histories.

For example, Members can add notes and comments to material obtained from doctors' offices and hospitals. At the same time, Members may not alter information sent by e-mail or electronic interface directly from a doctor's office, a hospital or a health plan. Members are not allowed to alter direct e-mails or other electronic transmissions from doctors and hospitals or health plans, because otherwise doctors would have little faith in the accuracy or clinical usefulness of the data in any PHR Health History.

Members know that, as time passes, more and more copies of medical records will be sent electronically directly from a doctor's office, hospital, or health plan. This method of getting information into Health Histories is both more convenient for Members and more authoritative in the eyes of the doctors who will see the entries later and seek to rely on them.

### Children's Health Histories Created and Controlled by Parents or Guardians

Many Members will want to start Health Histories for their children from the time they are born. Many Members also will want to control the Health Histories of their minor children. Even when the children grow up be adults, these parents want to be able to have full access to their children's health histories. Some children want to start their own Health Histories. In some families, this is done with their parents or guardian's knowledge and agreement. In some cases, however, minors want to start their own Health Histories in secret. The reasons for minors' wanting to do this are varied, and often are highly sensitive. The invention of course accommodates parents who want to create Health Histories for their minor children. The parent's instructions about who controls and has access to these Health Histories are valid and are followed for as long as the child is below the age of majority in the state where the child resides. Above that age, control of the Health History changes to that of the child (assuming the child wants to continue as a Member).

Among other things, this presents a choice for Members who have created Health Histories for children who are about to attain the age of majority in the state of the child's residence. Many Members in that position will want to make a full electronic copy of their child's Health History and retain that file on their personal computers.

The following disclosures and warranties are in the Member Agreement of one embodiment of the invention.
The process for inputting Members' medical information into a Health History includes a computer-based method for checking the input according to predetermined rules. This is Data Quality Review (DQR) Process. The purpose of DQR is to check and, where practicable, improve the accuracy of transcription of information in Members' Health Histories. This will help improve data quality in Health Histories.
The DQR process relates only to accuracy of transcription, that is, to what a doctor or other health professional recorded in a patient's medical record that is now being copied for input. This means that DQR process is not aimed at detecting other errors, such as errors in diagnosis or treatment, and it undertakes no duty to identify errors in diagnosis or treatment.
In the event that DQR process identifies possible inconsistencies in data input to Members' Health Histories, the invention may be able to report some of those inconsistencies. However, there is no duty to make reports of that nature, because doing so reliably may be beyond the capacity of the invention's systems. Therefore, among other things, the fact that the invention's systems may be able to report some possible inconsistencies in data input to Members' Health Histories does not mean, and should not be interpreted by anyone to guarantee, that the invention is able to identity and report any, some, or all possible inconsistencies in the data input to Members' Health Histories.
The invention's systems use a variety of security protections. Security measures are reviewed on an ongoing basis, and improve the system's security as conditions justify. These conditions include new technology available, the cost of security measures, the effectiveness of new security products and services in combination with existing security systems, and the threats to the security of systems and Members' creation, storage, and use of their Health Histories.
The invention faces security threats continually, as is true for any substantial business that uses the Internet. These threats include attempts to gain unauthorized access to the invention's systems, to disrupt the operation of the invention's systems, and to damage or destroy some or all of the invention's systems. Among these threats are attempts to hack into computer and communications systems by outsiders; attempts to fool or “spoof” the systems' security protections to gain unauthorized access to the invention's systems and the data stored in them (such as Members' Health Histories and business and technical information), and attempts to steal data about Members for illicit purposes such as identity theft. Threats also include attempts by employees and contractors to make unauthorized use of systems, whether to view information they are not authorized to see, to steal information, or to harm the invention's systems, Members, and business. Because of these and other threats, a variety of policies, technologies, and techniques are used to protect the security of the invention's systems and the privacy and security of Members.
The PHR may receive a valid order from a court or a government regulatory agency that forces the holder to give the government access to a Health History. In the event of such an order, the Member is notified unless the order forbids the invention from making the notification. (Under some government orders, such as orders issued under the U.S. Patriot Act, it may be forbidden to notify anyone that the order has been received and that access to records has been granted as required under the order.)
The invention has security measures in place to protect the security and privacy of its systems and of Members' Health Histories. These include measures to store information in redundant systems and to protect against possible natural disasters or man-made threats that might jeopardize the ability to continue its services without interruption. However, there are no security measures that guarantee security and privacy under all circumstances. Therefore, it is possible that security could be breached. For example, the PHR could be hacked successfully, or its computer and communications systems could be shut down despite our efforts to continue operating them. Under some circumstances, the disruption to the invention's services and its business could be substantial.

In some situations involving minors, people under guardianship, and similar situations, the privacy of Members' Health Histories and the ability of those members to restrict access to their Health Histories may be subject to varying requirements under the laws of different states. Under these circumstances, parents, guardians, or others acting in a similar capacity, and various law enforcement or health or social services or regulatory agencies, may be able to gain access to Health Histories despite the wishes of the Members.

Other embodiments and uses of the invention will be apparent to those skilled in the art from consideration of the specification and practice of the invention disclosed herein. All references cited herein, including all U.S. and foreign patents and patent applications such as U.S. Provisional No. 60/949,750, United States Patent Publication Nos. 2002/0016923 and 2002/0004727, and HIPAA, including all associated implementation statutes and regulations, are specifically and entirely hereby incorporated herein by reference. The term comprising is intended to include the terms consisting and consisting essentially of as appropriate. It is intended that the specification and examples be considered exemplary only.

1. An electronic health record comprising health care information obtained from multiple sources, wherein the information contains an indication of reliability.

2. The record of claim 1, wherein the indication of reliability is an identification of source information.

3. The record of claim 2, wherein the source is a hospital, a physician, a nurse, a pharmacy, the patient, or a combination thereof.

4. The record of claim 1, wherein the indication of reliability is an identification of mode of input by which the information is entered into the electronic health record.

5. The record of claim 4, wherein the mode of input is by imaging a paper record, by facsimile, by electronic transfer, by electronic mail, or by a combination thereof.

6. The record of claim 1, wherein the indication of reliability is optionally displayed on a screen.

7. The record of claim 1, which is owned, managed, and controlled by a patient or a person with authorization to act for the patient who is not a health care worker directly involved in creation or supplementation of the health care record.

8. A health record database comprising a plurality of the electronic health records of claim 1, wherein each record is capable of being individually displayed and individually supplemented with additional health information, wherein the indication of reliability contains both a source identification and a mode of input by which the information is entered into the record.

9. A method for creating or supplementing an electronic health record comprising:
inputting heath information of a patient into an electronic database; and
inputting an indication of the reliability of said information.

10. The method of claim 9, wherein the indication of reliability comprises a mode of input by which the information was acquired.

11. The method of claim 10, wherein the indication of reliability further comprises an identification of the source of the information.

12. The method of claim 11, wherein the indication of reliability is optionally displayed to a user.

13. The method of claim 12, wherein the indication of reliability is displayed or hidden by the click of an icon on a computer screen.

14. The method of claim 9, further comprising subjecting the electronic health record to a data quality review.

15. The method of claim 14, wherein the data quality review comprises a vetting process that identifies errors, duplications, omissions, inconsistencies or combinations thereof in medical information in the electronic medical record.

16. The method of claim 15, wherein the vetting process further comprises annotating the record to identify that there are suspected errors, duplications, omissions, inconsistencies or combinations thereof in the medical information of the electronic medical record.

17. The method of claim 16, wherein the vetting process comprises annotating the record to identify all suspected errors, duplications, omissions, and inconsistencies of the electronic medical record.

18. An electronic health record database comprising multiple electronic health records created or supplemented by the method of claim 9.

19. An electronic health record database comprising multiple electronic health records of multiple patients wherein the one or more of the electronic health records contains a primary personal health record component and an inactive archival component.

20. The electronic health record database of claim 19, wherein the inactive archival component is not accessible to a viewer of the primary personal health record component without authorization.
